(19) United States
(12) Patent Application Publication
(10) Pub. No.: US 2003/0227149 A1
(43) Pub. Date: Dec. 11, 2003

(54) Dolly with child car seat

(76) Inventor: Paul W. Budge, Washington, UT (US)

Correspondence Address: FEHR LAW FIRM, Goldenwest Corporate Center, 5025 Adams Avenue, Suite 300, Ogden, UT, 84403, US

(21) Appl. No.: 10/164,518

(22) Filed: Jun. 5, 2002

(51) Int. Cl. B62B 7/02; B62B 7/04

(52) U.S. Cl. 280/47.38

(57) ABSTRACT

A child car seat attached to a dolly with the dolly having a handle attached to the dolly near the rear of the dolly. A wheel is attached to the dolly below the handle, and all components of the invention are constructed so that the overall center of gravity for the invention when a child typical of those who use child car seats occupies the child car seat will be in front of and near an imaginary vertical line drawn through the center of rotation for said wheel. Optionally, the invention includes one or more of the following: a stop placed upon the bottom of said dolly near the front of said dolly so that it will contact a surface upon which said dolly is located when said dolly is not tilted for movement, a friction-reduction device attached to the back of said handle, a second friction-reduction device attached to the bottom of said dolly, and a lock for attaching the dolly to a tray on a seat of an automobile or for attaching the child car seat to such tray when the child car seat is removably attached to the dolly.

### BACKGROUND OF THE INVENTION

1. Field of the Invention

This invention relates to child car seats and dollies and, more particularly, to a child car seat which can be used both in an automobile as a conventional car seat and on a dolly for pushing or, preferably, pulling.

2.Description of the Related Art

Numerous patents exist for child car seats which can be used both in an automobile on as part of a stroller.

These include U.S. Pat. Nos. 6,209,892; 6,012,729; 5,707,106; 5,595,393; 5,499,821; 5,403,022; 5,398,951; 5,385,386; 5,318,311; 5,149,113; 5,121,940; 5,104,134; 4,989,888; 4,921,261; 4,878,680; 4,874,182; 4,872,693; 4,872,692; 4,852,894; 4,828,281; 4,822,064; 4,768,795; 4,762,331; 4,685,688; 4,679,804; 4,678,196; 4,647,054; 4,641,844; 4,632,409; 4,620,711; 4,570,956; 4,537,414; 4,157,837; 4,019,751; 3,984,115; 3,971,079; 3,944,241; 3,829,113; 3,116,069; D0421940; D0345720; D0332590; D0310054; and D0306711.

None of these patents, however, include a skid or rollers for moving the dolly up or down stairs. Nor do any of these patents have only wheels near the rear of the dolly for minimizing weight toward the front and thereby facilitating moving the dolly with the child car seat attached only upon the rear wheel or wheels. And, finally, none of the preceding patents have a chair which can be placed and locked into a mounting tray in a car from the side.

### SUMMARY OF THE INVENTION

The Dolly with Child Car Seat of the present invention is constructed in several ways to facilitate tilting the dolly and seat upon one or two wheels for movement while both minimizing the possibility that a child in the seat can cause the seat to tip backwards and assuring that if a user loses the user's grip upon the handle, the dolly and seat will rotate forward and stop.

The dolly and car seat preferably has only one or two wheels and has such wheels located near the rear of the dolly and preferably below a handle for the dolly. It is, furthermore, designed to have a center of gravity, including the weight of a child typical of those who use child car seats, near, but in front of, an imaginary vertical line running through the center of rotation for the wheel or wheels. And a stop is attached to the bottom of the dolly where the dolly would otherwise contact the surface upon which the dolly is located.

Movement of the dolly and car seat over steps is, furthermore, facilitated by an optional friction-reduction device, such as a skid or rollers. One such device is optionally located on the back of the handle near the rear wheel or wheels, and another is optionally placed on the bottom of the dolly.

In order to facilitate installing the Dolly with Child Car Seat upon a seat of a car and removing the Dolly with Child Car Seat from a seat of a car, a guide and a portion of a lock is placed on a tray attached to the seat of a car and a mating portion of the lock is placed upon the bottom of the car seat so that the seat can be placed on the tray from the side.

### BRIEF DESCRIPTION OF THE DRAWINGS

FIG. 1 shows the overall Dolly with Child Car Seat.

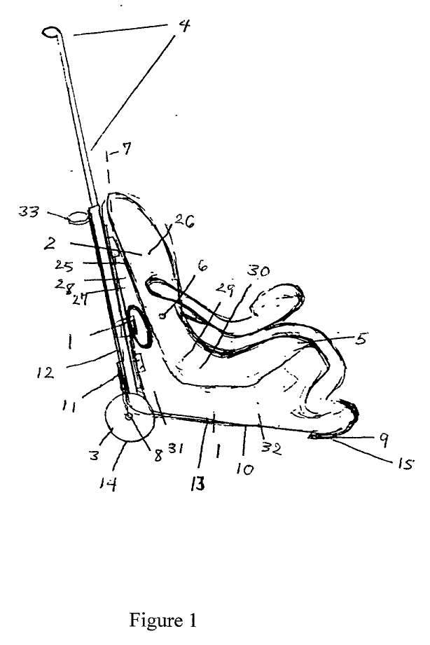

FIG. 2 illustrates a guide and portion of a lock on a tray as well as the mating portion of the lock on the bottom of the dolly.

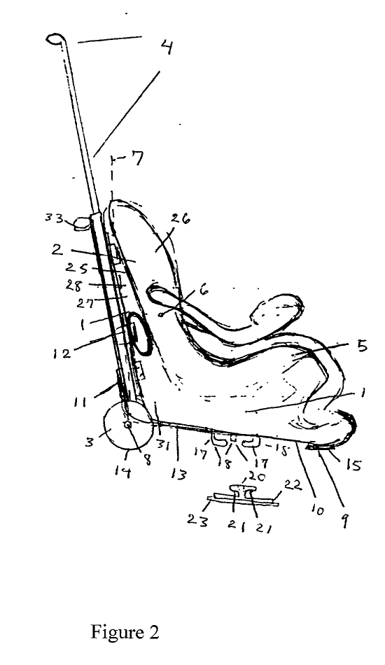

FIG. 3 depicts the Dolly with Child Car Seat having supplemental wheels.

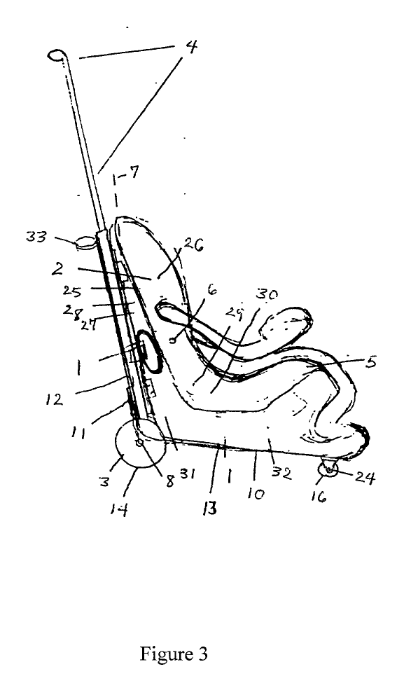

### DESCRIPTION OF THE PREFERRED EMBODIMENT

The present invention includes a dolly 1 for holding a child car seat 2 and such a seat 2 with the dolly 1 attached to the child car seat 2.

The dolly 1 preferably has only one or two wheels 3, which are located near the rear 4 of the dolly 1 and are preferably below a handle 4 for the dolly 1 to minimize weight toward the front 5 of the car seat 2 and dolly 1 and thereby facilitating moving the dolly 1 with the child car seat 2 attached only upon the rear wheel 3 or wheels 3.

Also, preferably the Dolly with Child Car Seat is constructed so that the center of gravity 6 of the combined dolly 1, child car seat 2, handle 4, and a child of average size for using a child car seat 2 occupying the child car seat 2 occupies the child car seat 2 will be near an imaginary vertical line 7 drawn through the center of rotation 8 for the wheel 3 or wheels 3. This further minimizes the effort needed to tilt the dolly 1 with the car seat 2 and child backwards so that it can be moved.

While maintaining the center of gravity 6 of the combined dolly 1, child car seat 2, handle 4, and child of average size for using a child car seat 2 occupies the child car seat 2, near the imaginary vertical line 7 drawn through the center of rotation 8 for the wheel 3 or wheels 3, the combined dolly 1, child car seat 2, and handle 4 is additionally preferably constructed so that such center of gravity 6 will be in front of the imaginary vertical line 7. In addition to the minimization of the effort necessary to tilt and to maintain the loaded unit in the tilted position for movement, this further decreases the possibility of a child in the child car seat 2 being able to tip the combined dolly 1 and child car seat 2 backward while also assuring that, when the combined unit is holding a child, it will not fall backward if one pushing or pulling it accidentally loses one's grip upon the handle 4.

Moreover, a high-friction projection, i.e., a stop 9, is preferably placed upon the bottom 10 of the dolly 1 near the front 5 of such dolly 1 so that it will contact the surface upon which the dolly 1 is located in order to stabilize and deter movement of the combined dolly 1 and car seat 2 when it is not tilted for movement.

The handle 4 is preferably collapsible, i.e., foldable or retractable, utilizing any technology that is well known in the art. And if the dolly 1 has more than one rear wheel 3, such rear wheels 3 preferably rotate independently of one another.

An additional preferable option is a first friction-reduction device 11, such as a skid or rollers or a rolling belt, which is attached to the back 12 of the handle 4 preferably near the rear wheel 3 or wheels 3 to facilitate moving the dolly 1 up or down stairs. For this same purpose, a second friction-reduction device 13, such as a skid or rollers or a rolling belt, for example, is optionally attached to the bottom 10 of the dolly 1 in such a location that it will not interfere with the operation of the stop 9, when a stop 9 is employed.

In operating the Dolly with Child Car Seat, a user will primarily pull, rather than push, the car seat and dolly because such a technique makes opening doors easier.

In a first embodiment, the dolly 1 is an integral part of the child car seat 2. With this first embodiment, in the resting position, the lowest portion 14 of the rear wheel 3 or wheels 3 is substantially level with the bottom 15 of the stop 9 that is attached to the bottom 10 of the dolly 1. This facilitates placing the dolly 1 and child car seat 2 onto the seat of a car. Also with this first embodiment, any front or supplemental wheels 16 that are utilized use any means that is well known in the art to be retractable so that the dolly 1 can be placed conveniently in a seat of a car. In a second embodiment, the child car seat 2 is separate from the dolly 1 and, utilizing any means that is well known in the art, is releasably attached to the dolly 1.

And, preferably, a first portion 17 of a lock 18 is attached to the bottom 10 of the dolly 1 (or, in the case of the second embodiment, to the bottom 19 of the child car seat 2) with a second or mating portion 20 of the lock 17 and a guide 21 or guides 21 to direct the first portion 17 of the lock 18 (which is on the dolly 1, or, in the case of the second embodiment, on the car seat 20) into the mating portion 20 of the lock 18 connected to a tray 22 that is removably or permanently attached to the seat of a car and so oriented that the child car seat 2 and dolly 1 (or, in the case of the second embodiment, only the child car seat 2) can be placed on and locked to such tray 22 from the side. (Any lock 18 and guide 21 or guides 21 that are well known in the art can be utilized; a preferred lock 18 and guide 21 or guides 21 is a small version of those that are utilized to hook the trailer of a semi-trailer truck to the tractor of such a truck.) In order to keep the seat of the car clean, a pad 23 is optionally placed under the tray 22.

A further option, as suggested above, is a supplemental wheel 16 or wheels 16, the axle 24 for which is either be rigidly or rotatably mounted to the dolly 1 and is placed near the front of the dolly 1 in lieu of the stop 9. Preferably, moreover, such supplemental wheel 16 or wheels 16 are equipped with any locking device that is well known in the art. When a supplemental wheel 16 or wheels 16 are utilized, a user locks these wheels 16 to prevent undesired movement of the dolly 1.

Also optionally, the rear 25 of the upper portion 26 of the child car seat 2 and the rear 27 of any portion 28 of the dolly 1 that extends behind the child car seat 2 is, using any method that is well known in the art, rotatably and lockably attached to the rear 29 of the lower portion 30 of the child car seat 2 and the rear 31 of the lower portion 32 of the dolly 1 so that the dolly 1 and child car seat 2 can be folded forward for storage but also locked into an upright position for use. (It is optional whether the dolly 1 extends behind the child car seat 2; and if the dolly 1 does not extend behind the child car seat 2, only the child car seat 2 rotates.)

And a still further option is a cup holder 29 that is attached to the handle 4 or to the child car seat 2.

Preferably, a child is harnessed into the child car seat 2 using any method that is well known in the art.

When additional components are, as discussed above, added to the basic dolly 1, child car seat 2, and handle 4, the overall center of gravity for the dolly 1, child car seat 2, handle 4, additional components, and child of average size for using a child car seat 2, is maintained in front of and near the imaginary vertical line 7 drawn through the center of rotation 8 for the wheel 3 or wheels 3.

I claim:

1. A dolly with child car seat, which comprises:
a child car seat;
a dolly attached to said child car seat, said dolly having a front, a rear, and a bottom;
a handle attached to said dolly near the rear of said dolly, said handle having a back; and
a wheel attached to said dolly below said handle, wherein said child car seat, said dolly, and said handle are so constructed that the overall center of gravity for said child car seat, said dolly, said handle, and a child typical of those who use child car seats occupying said car seat will be in front of and near an imaginary vertical line drawn through the center of rotation for said wheel.

2. The dolly with child car seat as recited in claim 1, further comprising:
a stop placed upon the bottom of said dolly near the front of said dolly so that it will contact a surface upon which said dolly is located when said dolly is not tilted for movement, wherein said child car seat, said dolly, said handle, and said stop are so constructed that the overall center of gravity for said child car seat, said dolly, said handle, said stop, and a child typical of those who use child car seats occupying said car seat will be in front of and near an imaginary vertical line drawn through the center of rotation for said wheel.

3. The dolly with child car seat as recited in claim 2, further comprising:
a friction-reduction device attached to the back of said handle; and
a second friction-reduction device attached to the bottom of said dolly, wherein said child car seat, said dolly, said handle, said stop, said friction-reduction device, and said second friction-reduction device are so constructed that the overall center of gravity for said child car seat, said dolly, said handle, said stop, said friction-reduction device, said second friction-reduction device, and a child typical of those who use child car seats occupying said car seat will be in front of and near an imaginary vertical line drawn through the center of rotation for said wheel.

4. The dolly with child car seat as recited in claim 3, wherein:
said handle is collapsible.

5. The dolly with child car seat as recited in claim 4, further comprising:
a first portion of a lock attached to the bottom of said dolly;
a tray;
a mating portion of the lock attached to said tray; and
a guide attached to said tray, wherein said child car seat, said dolly, said handle, said stop, said friction-reduction device, said second friction-reduction device, and said first portion of a lock are so constructed that the overall center of gravity for said child car seat, said dolly, said handle, said stop, said friction-reduction device, said second friction-reduction device, said first portion of a lock, and a child typical of those who use child car seats occupying said car seat will be in front of and near an imaginary vertical line drawn through the center of rotation for said wheel.

6. The dolly with child car seat as recited in claim 4, wherein:
said child car seat is releasably attached to said dolly, and said child car seat has a bottom; and further comprising:
a first portion of a lock attached to the bottom of said child car seat;
a tray;
a mating portion of the lock attached to said tray; and
a guide attached to said tray, wherein said child car seat, said dolly, said handle, said stop, said friction-reduction device, said second friction-reduction device, and said first portion of a lock are so constructed that the overall center of gravity for said child car seat, said dolly, said handle, said stop, said friction-reduction device, said second friction-reduction device, said first portion of a lock, and a child typical of those who use child car seats occupying said car seat will be in front of and near an imaginary vertical line drawn through the center of rotation for said wheel.

7. The dolly with child car seat as recited in claim 3, further comprising:
a first portion of a lock attached to the bottom of said dolly;
a tray;
a mating portion of the lock attached to said tray; and
a guide attached to said tray, wherein said child car seat, said dolly, said handle, said stop, said friction-reduction device, said second friction-reduction device, and said first portion of a lock are so constructed that the overall center of gravity for said child car seat, said dolly, said handle, said stop, said friction-reduction device, said second friction-reduction device, said first portion of a lock, and a child typical of those who use child car seats occupying said car seat will be in front of and near an imaginary vertical line drawn through the center of rotation for said wheel.

8. The dolly with child car seat as recited in claim 3, wherein:
said child car seat is releasably attached to said dolly, and said child car seat has a bottom; and further comprising:
a first portion of a lock attached to the bottom of said child car seat;
a tray;
a mating portion of the lock attached to said tray; and
a guide attached to said tray, wherein said child car seat, said dolly, said handle, said stop, said friction-reduction device, said second friction-reduction device, and said first portion of a lock are so constructed that the overall center of gravity for said child car seat, said dolly, said handle, said stop, said friction-reduction device, said second friction-reduction device, said first portion of a lock, and a child typical of those who use child car seats occupying said car seat will be in front of and near an imaginary vertical line drawn through the center of rotation for said wheel.

9. The dolly with child car seat as recited in claim 2, wherein:
said handle is collapsible.

10. The dolly with child car seat as recited in claim 9, further comprising:
a first portion of a lock attached to the bottom of said dolly;
a tray;
a mating portion of the lock attached to said tray; and
a guide attached to said tray, wherein said child car seat, said dolly, said handle, said stop, and said first portion of a lock are so constructed that the overall center of gravity for said child car seat, said dolly, said handle, said stop, said first portion of a lock, and a child typical of those who use child car seats occupying said car seat will be in front of and near an imaginary vertical line drawn through the center of rotation for said wheel.

11. The dolly with child car seat as recited in claim 9, wherein:
said child car seat is releasably attached to said dolly, and said child car seat has a bottom; and further comprising:
a first portion of a lock attached to the bottom of said child car seat;
a tray;
a mating portion of the lock attached to said tray; and
a guide attached to said tray, wherein said child car seat, said dolly, said handle, said stop, and said first portion of a lock are so constructed that the overall center of gravity for said child car seat, said dolly, said handle, said stop, said first portion of a lock, and a child typical of those who use child car seats occupying said car seat will be in front of and near an imaginary vertical line drawn through the center of rotation for said wheel.

12. The dolly with child car seat as recited in claim 2, further comprising:
a first portion of a lock attached to the bottom of said dolly;
a tray;
a mating portion of the lock attached to said tray; and
a guide attached to said tray, wherein said child car seat, said dolly, said handle, said stop, and said first portion of a lock are so constructed that the overall center of gravity for said child car seat, said dolly, said handle, said stop, said first portion of a lock, and a child typical of those who use child car seats occupying said car seat will be in front of and near an imaginary vertical line drawn through the center of rotation for said wheel.

13. The dolly with child car seat as recited in claim 2, wherein:
said child car seat is releasably attached to said dolly, and said child car seat has a bottom; and further comprising:
a first portion of a lock attached to the bottom of said child car seat;
a tray;
a mating portion of the lock attached to said tray; and
a guide attached to said tray, wherein said child car seat, said dolly, said handle, said stop, and said first portion of a lock are so constructed that the overall center of gravity for said child car seat, said dolly, said handle, said stop, said first portion of a lock, and a child typical of those who use child car seats occupying said car seat will be in front of and near an imaginary vertical line drawn through the center of rotation for said wheel.

14. The dolly with child car seat as recited in claim 1, further comprising:
a friction-reduction device attached to the back of said handle; and
a second friction-reduction device attached to the bottom of said dolly, wherein said child car seat, said dolly, said handle, said friction-reduction device, and said second friction-reduction device are so constructed that the overall center of gravity for said child car seat, said dolly, said handle, said friction-reduction device, said second friction-reduction device, and a child typical of those who use child car seats occupying said car seat will be in front of and near an imaginary vertical line drawn through the center of rotation for said wheel.

15. The dolly with child car seat as recited in claim 14, wherein:
said handle is collapsible.

16. The dolly with child car seat as recited in claim 15, further comprising:
a first portion of a lock attached to the bottom of said dolly;
a tray;
a mating portion of the lock attached to said tray; and
a guide attached to said tray, wherein said child car seat, said dolly, said handle, said friction-reduction device, said second friction-reduction device, and said first portion of a lock are so constructed that the overall center of gravity for said child car seat, said dolly, said handle, said friction-reduction device, said second friction-reduction device, said first portion of a lock, and a child typical of those who use child car seats occupying said car seat will be in front of and near an imaginary vertical line drawn through the center of rotation for said wheel.

17. The dolly with child car seat as recited in claim 15, wherein:
said child car seat is releasably attached to said dolly, and said child car seat has a bottom; and further comprising:
a first portion of a lock attached to the bottom of said child car seat;
a tray;
a mating portion of the lock attached to said tray; and
a guide attached to said tray, wherein said child car seat, said dolly, said handle, said friction-reduction device, said second friction-reduction device, and said first portion of a lock are so constructed that the overall center of gravity for said child car seat, said dolly, said handle, said friction-reduction device, said second friction-reduction device, said first portion of a lock, and a child typical of those who use child car seats occupying said car seat will be in front of and near an imaginary vertical line drawn through the center of rotation for said wheel.

18. The dolly with child car seat as recited in claim 14, further comprising:
a first portion of a lock attached to the bottom of said dolly;
a tray;
a mating portion of the lock attached to said tray; and
a guide attached to said tray, wherein said child car seat, said dolly, said handle, said friction-reduction device, said second friction-reduction device, and said first portion of a lock are so constructed that the overall center of gravity for said child car seat, said dolly, said handle, said friction-reduction device, said second friction-reduction device, said first portion of a lock, and a child typical of those who use child car seats occupying said car seat will be in front of and near an imaginary vertical line drawn through the center of rotation for said wheel.

19. The dolly with child car seat as recited in claim 14, wherein:
said child car seat is releasably attached to said dolly, and said child car seat has a bottom; and further comprising:
a first portion of a lock attached to the bottom of said child car seat;
a tray;
a mating portion of the lock attached to said tray; and
a guide attached to said tray, wherein said child car seat, said dolly, said handle, said friction-reduction device, said second friction-reduction device, and said first portion of a lock are so constructed that the overall center of gravity for said child car seat, said dolly, said handle, said friction-reduction device, said second friction-reduction device, said first portion of a lock, and a child typical of those who use child car seats occupying said car seat will be in front of and near an imaginary vertical line drawn through the center of rotation for said wheel.

20. The dolly with child car seat as recited in claim 1, wherein:
said handle is collapsible.

21. The dolly with child car seat as recited in claim 20, further comprising:
a first portion of a lock attached to the bottom of said dolly;
a tray;
a mating portion of the lock attached to said tray; and
a guide attached to said tray, wherein said child car seat, said dolly, said handle, and said first portion of a lock are so constructed that the overall center of gravity for said child car seat, said dolly, said handle, said first portion of a lock, and a child typical of those who use child car seats occupying said car seat will be in front of and near an imaginary vertical line drawn through the center of rotation for said wheel.

22. The dolly with child car seat as recited in claim 20, wherein:
said child car seat is releasably attached to said dolly, and said child car seat has a bottom; and further comprising:
a first portion of a lock attached to the bottom of said child car seat;
a tray;
a mating portion of the lock attached to said tray; and
a guide attached to said tray, wherein said child car seat, said dolly, said handle, and said first portion of a lock are so constructed that the overall center of gravity for said child car seat, said dolly, said handle, said first portion of a lock, and a child typical of those who use child car seats occupying said car seat will be in front of and near an imaginary vertical line drawn through the center of rotation for said wheel.

23. The dolly with child car seat as recited in claim 1, further comprising:
a first portion of a lock attached to the bottom of said dolly;
a tray;
a mating portion of the lock attached to said tray; and
a guide attached to said tray, wherein said child car seat, said dolly, said handle, and said first portion of a lock are so constructed that the overall center of gravity for said child car seat, said dolly, said handle, said first portion of a lock, and a child typical of those who use child car seats occupying said car seat will be in front of and near an imaginary vertical line drawn through the center of rotation for said wheel.

24. The dolly with child car seat as recited in claim 1, wherein:
said child car seat is releasably attached to said dolly, and said child car seat has a bottom; and further comprising:
a first portion of a lock attached to the bottom of said child car seat;
a tray;
a mating portion of the lock attached to said tray; and
a guide attached to said tray, wherein said child car seat, said dolly, said handle, and said first portion of a lock are so constructed that the overall center of gravity for said child car seat, said dolly, said handle, said first portion of a lock, and a child typical of those who use child car seats occupying said car seat will be in front of and near an imaginary vertical line drawn through the center of rotation for said wheel.
